(19) United States
(12) Patent Application Publication
(10) Pub. No.: US 2025/0249555 A1
(43) Pub. Date: Aug. 7, 2025

(54) TRUSS-ROD ADJUSTMENT TOOL

(71) Applicant: Lee Carter, Minneapolis, MN (US)

(72) Inventor: Lee Carter, Minneapolis, MN (US)

(21) Appl. No.: 18/434,591

(22) Filed: Feb. 6, 2024

(51) Int. Cl. B25B 15/00; G10D 1/08

(52) U.S. Cl. CPC B25B 15/004; G10D 1/08

(57) ABSTRACT

A specialized tool is able to adjust the truss rod within the neck of a stringed musical instrument, even while the instrument remains fully assembled and the instrument's body partially obscures the head of the truss-rod adjustment screw. In general, the tool includes: an elongated handle defining a proximal end, a distal end, and a central longitudinal axis extending from the proximal end to the distal end; and an engagement head coupled to the distal end of the elongated handle. In certain examples, the tool includes a single-blade-type engagement head at one end of the handle, and a two-prong-type engagement head at the opposite end of the handle.

### TECHNICAL FIELD

The present technology relates generally to musical instruments.

### BACKGROUND

Certain models of stringed musical instruments (e.g., guitars, bass guitars, cellos, etc.) include a reinforcing “truss rod” that extends longitudinally through the neck of the instrument. Some such instruments further include an adjustment mechanism—most often a standard flathead or Phillips-head screw—that enables the musician to apply or relieve tension along the truss rod in order to straighten the neck of the instrument. As an illustrative example, certain guitars made by Fender Musical Instruments Corp., of Los Angeles, California, feature a standard flathead-type screw where the butt of the neck meets the body of the guitar. Typically, while the instrument remains fully assembled, the head of the truss-rod adjustment screw is at least partially obscured by some portion of the body. That is, in order to adjust the truss rod, the musician must first disassemble at least a portion of the instrument to fully access the head of the screw. At the very least, this disassembly process involves disconnecting all of the strings to remove tension from the neck, but more often requires fully disengaging the neck from the body. In some cases, removing the pickguard from the surface of the guitar's body can improve access to the screw, but but for certain orientations of the screw, this is still not enough. In many cases, the musician often discovers, after screw-adjustment and reassembly, that precise alignment of the neck has not yet been achieved, requiring them to repeat the disassembly process any number of times, making for a tedious and frustrating endeavor. On rare occasions, the screw may be precisely oriented in a position that allows the musician to briefly access and turn the screw by up to a few degrees of rotation while the instrument remains full assembled. In such cases, the musician assumes substantial risk of damaging the instrument, e.g., by scratching and gouging the instrument body with the tip of the screwdriver.

### SUMMARY OF THE DISCLOSURE

The techniques of this disclosure generally relate to specialized tools for stringed musical instruments. In particular, the following description illustrates various example features of a truss-rod screwdriver tool that enables a user to adjust the neck of the musical instrument while the instrument remains fully assembled. More specifically, the engagement heads of the highly specialized screwdriver tools are configured to access and rotate the truss-rod adjustment screw even while the head of the screw remains partially obscured by the body of the musical instrument.

In some examples, the engagement head of the tool is a single, generally planar blade aligned substantially parallel with the central longitudinal axis of the tool's handle. In some such examples, the blade includes a sinusoidal outer edge configured to maneuver around the obscuring edge of the body of the instrument. Such heads can be used to adjust flathead screws as well as Phillips-head screws.

In some examples, the engagement head of the tool includes two elongated prongs extending generally perpendicular to the elongated handle, with respective outer edges oriented at right angles to one another. Such heads are configured specifically for Phillips-head screws.

In some examples, the screwdriver tool includes a different engagement head at either end of the elongated handle—i.e., a single-blade-type head at the proximal end, and a two-prong-type head at the distal end.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view of an example of a neck of a stringed instrument, and in particular, a truss-rod adjustment screw at the base of the instrument's neck.

FIG. 2A is a perspective view of a first example tool for adjusting the truss-rod screw of FIG. 1, wherein the engagement head of the tool features a single blade adapted for both Flathead screws and Phillips-head screws.

FIG. 2B is a bottom view of the single-bladed tool of FIG. 2A.

FIG. 2C is a side view of the single-bladed tool of FIGS. 2A and 2B.

FIG. 3 is a closeup view of the engagement head of the single-bladed tool of FIGS. 2A-2C.

FIG. 4A illustrates a user aligning the tool of FIGS. 2A-3 with the truss-rod adjustment screw of FIG. 1.

FIG. 4B illustrates the user inserting the tool of FIGS. 2A-3 into the head of the truss-rod adjustment screw of FIG. 1.

FIG. 4C illustrates the tool of FIGS. 2A-3 fully engaged with the head of the adjustment screw of FIG. 1.

FIG. 5A is a perspective view of a second example tool for adjusting the truss-rod screw of FIG. 1, wherein the engagement head of the tool features two prongs adapted for Phillips-head screws.

FIG. 5B is a bottom view of the tool of FIG. 5A.

FIG. 5C is a side view of the tool of FIGS. 5A and 5B.

FIG. 6 is a closeup view of the engagement head of the tool of FIGS. 5A-5C.

FIG. 7A illustrates the user aligning the tool of FIGS. 5A-6 into the head of the adjustment screw of FIG. 1.

FIG. 7B illustrates the tool of FIGS. 5-6 fully engaged with the head of the adjustment screw of FIG. 1.

FIG. 8A is a perspective view of a third example tool for adjusting the truss-rod screw of FIG. 1, wherein the tool includes a single-blade engagement head at the proximal end of the handle, and a two-prong engagement head at the distal end of the handle.

FIG. 8B is an underside view or bottom view of the double-ended tool of FIG. 8A.

FIG. 8C is a side view of the double-ended tool of FIGS. 8A and 8B.

FIG. 9A is a perspective view of another example of the double-ended tool of FIGS. 8A-8C, including an integrated action ruler.

FIG. 9B is an underside view of the double-ended tool of FIG. 9A.

FIG. 9C is a side view of the double-ended tool of FIGS. 9A and 9B.

FIG. 10A is a perspective view of the double-ended tool of FIGS. 9A-9C.

FIG. 10B is a close-up perspective view of a distal portion of the double-ended tool of FIG. 10A.

FIG. 10C is a close-up perspective view of a proximal portion of the double-ended tool of FIG. 10A.

FIG. 11A is an underside view of the double-ended tool of FIGS. 9A-9C.

FIG. 11B is a close-up underside view of a distal portion of the double-ended tool of FIG. 11A.

FIG. 11C is a close-up underside view of a proximal portion of the double-ended tool of FIG. 11A.

FIG. 12A is a perspective view of the double-ended tool of FIGS. 9A-9C.

FIG. 12B is a close-up perspective view of a distal portion of the double-ended tool of FIG. 12A, with the distal engagement head engaged with an example truss-rod adjustment screw.

FIG. 12C is a close-up perspective view of a proximal portion of the double-ended tool of FIG. 12A, with the proximal engagement head engaged with an example truss-rod adjustment screw.

FIG. 13 is a close-up overhead view of a portion of the handle of the double-ended tool of FIGS. 9A-9C.

FIG. 14 is a close-up side view of a portion of the handle of the double-ended tool of FIGS. 9A-9C.

FIG. 15 is a close-up side view of a portion of the handle of the double-sided tool of FIGS. 9A-9C.

FIG. 16 is a flowchart describing a method for adjusting the truss rod within the neck of a stringed musical instrument while the instrument remains fully assembled and while the truss-rod adjustment screw remains partially obscured by the body of the instrument.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

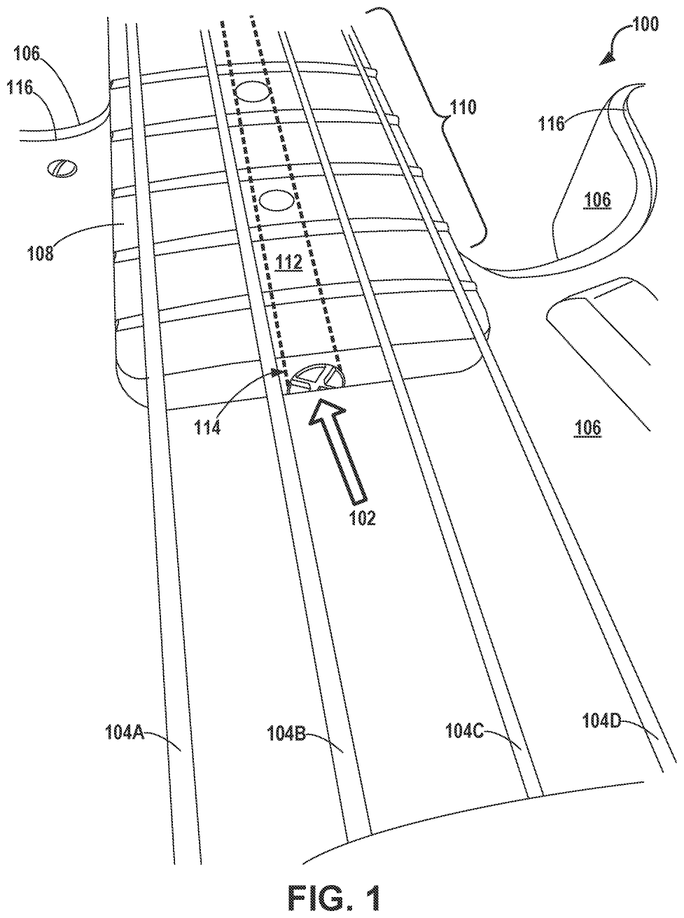

FIG. 1 illustrates one example of a stringed musical instrument 100 having a truss-rod adjustment screw 102. In particular, stringed instrument 100 is depicted throughout the present figures as a bass guitar (hereinafter, “bass 100”) having four strings 104A-104D (collectively, “strings 104”). However, it is to be understood that the devices, techniques, and concepts of this disclosure can be equally applied to any other relevant stringed instrument, such as a guitar, a cello, a ukulele, or the like, that features a similarly situated truss-rod screw 102.

As typical of stringed musical instruments, bass 100 includes a main body 106, and an elongated wooden neck 108 that defines a fret board 110 along its top surface. Bass 100 further includes a truss rod 112, indicated by the parallel dashed lines running between center strings 104B and 104C. Truss rod 112 is an elongated device that extends longitudinally underneath fretboard 110 to provide structural support for neck 108. For this purpose, truss rod 112 is formed from a substantially firm, durable material, such as carbon steel, alloy steel, or, preferably, stainless steel. Other suitable materials include, as non-limiting examples: metal carbide, ceramics, or any suitably durable plastic or resin, such as polyoxymethylene (POM, available from Delrin USA, headquartered in Wilmington, Delaware).

In addition to providing structural support to neck 108, truss rod 112 serves a secondary function, in that it enables a user to control an alignment of neck 108 relative to strings 104. For instance, over an extended period of time, the tension force from strings 104 can cause the softer wood material to bow downward away from the strings, such that fretboard 110 defines a generally concave upper surface. Even with the strings removed, the wooden neck 108 tends to naturally deform due to, for example, changes in temperature, pressure, and humidity. Truss rod 112 provides a mechanism to compensate for these changes, which would otherwise begin to affect the quality of sound produced by bass 100.

Specifically, truss rod 112 is rigidly coupled to the inside of neck 108 at its proximal end 114 (i.e., near adjustment screw 102), and also at its distal end (i.e., near the tuning pegs of bass 100, not shown in FIG. 1). From this configuration, the rotation of adjustment screw 102 in a certain direction either increases or relieves the internal tension force applied by truss rod 112 to the interior of neck 108. The change in internal tension causes neck 108 to bend, either upward toward strings 104 (i.e., such that fretboard 110 forms a more-convex surface) or downward away from strings 104 (i.e., such that fretboard 110 forms a more-concave surface). The distance between the fretboard 110 and the strings 104 due to the relative curvature of neck 108 is referred to as the “action” of the instrument 100. The user (i.e., musician) can modify the action, as-needed to improve the quality of sound, simply by loosening or tightening adjustment screw 102.

For many stringed instruments produced today, the truss-rod adjustment screw is a small, inobtrusive hex nut at the base of the neck, conveniently adjustable with an appropriate-sized hex key (or “Allen wrench”). Numerous other models of stringed instruments, however, require the user to at least partially disassemble the instrument in order to adjust truss rod 112. In minor cases, for instance, this involves disconnecting all of strings 104 to relieve the external tension force applied to neck 108. In certain intermediate cases, removing the plastic pickguard 116 that covers the top surface of the body 106 might expose enough of screw 102 for access with the appropriate tool. In more extreme cases, such as the bass guitar 100 depicted in FIG. 1, the head of adjustment screw 102 is sufficiently obscured by the body 106 of the instrument that the user must fully separate the neck 108 from the body 106 in order to access the screw 102.

Specifically, in the example shown in FIG. 1, truss-rod adjustment screw 102 features a standard Phillips-type head (i.e., defining an X-shaped groove), the bottom half of which is substantially obscured by the body 106. A Phillips-head screwdriver of any size could not engage with the head of screw 102 while bass 100 remains in this assembled state. In certain orientations, a significantly under-sized flathead screwdriver could potentially rotate the screw 102, i.e., via a straight-on engagement, but misaligned with the central axis of the screw. However, this presents its own set of problems in that: (1) the screw could only rotate by just an incremental amount before requiring the user to re-engage with a different, unobscured portion of the X-shaped groove; (2) this would require a substantial amount of very-precisely applied leverage, as the typical twisting motion of a screwdriver would not work; and (3) the misalignment in both size and shape between the screwhead and the screwdriver presents a risk of the screwdriver slipping and causing permanent scratch damage to the body 106 and/or neck 108 around the periphery of the screw 102.

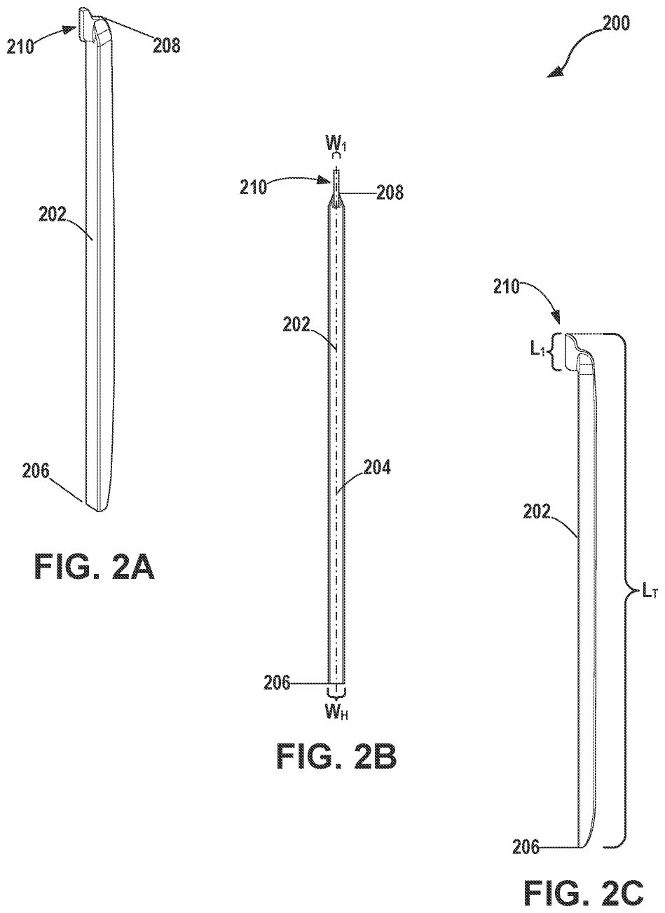

In general, the techniques of this disclosure provide for a class of specialized tools that enable a musician to tighten and/or loosen their truss-rod screw 102 of their stringed musical instrument 100 while the head of the screw 102 remains partially obscured by the instrument's body 106, and while requiring minimal applied torque. A first such tool is illustrated in the examples shown in FIGS. 2A-4C. Specifically, FIG. 2A is an oblique view, FIG. 2B is a bottom view, and FIG. 2C is a side view, of a first example truss-rod-screw adjustment tool 200 (hereinafter, “tool 200,” or alternatively, “screwdriver 200”).

As shown in FIGS. 2A-2C, tool 200 includes an elongated handle 202, defining a central longitudinal axis 204 (indicated by the dashed line in FIG. 2B). Central axis 204 extends from a proximal end 206 of handle 202 to a distal end 208 of the handle 202. As shown in FIG. 2B, handle 202 defines a handle width W_{H} of about one-eighth inch (about 0.32 centimeters (cm)), as measured perpendicular to central longitudinal axis 204. As shown in FIG. 2C, tool 200 defines an overall tool length L_{T} of about 5⅛ inches (about 13 cm), as measured parallel to central longitudinal axis 204.

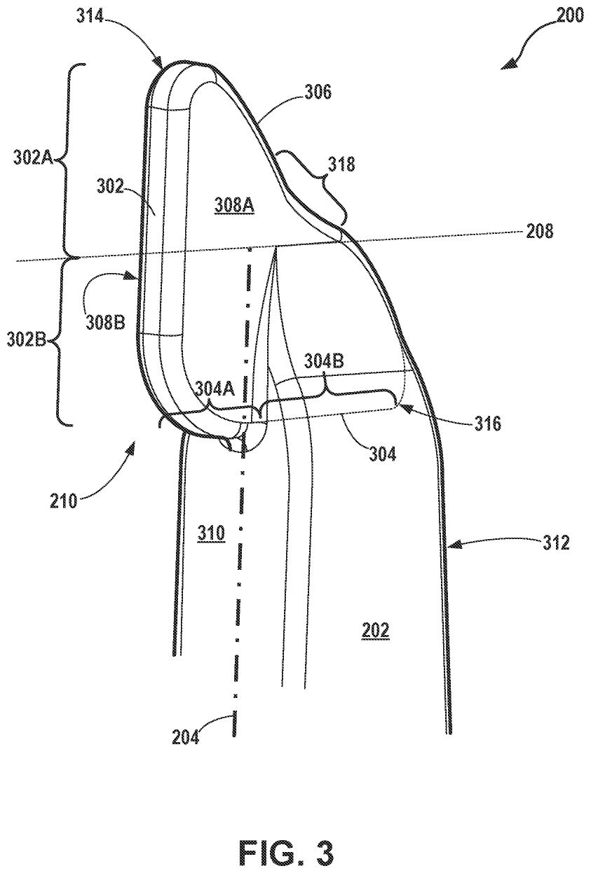

Tool 200 further includes an engagement head 210 at the distal end 208 of elongated handle 202. The engagement head 210 is illustrated in greater detail in FIG. 3. In some examples, engagement head 210 is integrally formed with handle 202, e.g., from a unitary length of material. In other examples, handle 202 and engagement head 210 are initially formed as physically distinct components (whether from a common or different type of material), and then rigidly coupled (e.g., glued, welded, fused, soldered, nailed, etc.) together. In yet other examples, handle 202 and engagement head 210 are removably coupled to one another. For instance, engagement head 210 can be configured to snap into place within the distal end 208 of handle 202, or can be screwed into place within the distal end 208 of handle 202, or any other mechanism by which engagement head 210 can be non-destructively removed from handle 202 at will.

As shown in FIG. 2B, engagement head 210 defines a head width W₁ of about 1/32 inch (about 0.08 cm) to about 3/32 inch (about 0.24 cm), as measured perpendicular to central longitudinal axis 204. As shown in FIG. 2C, engagement head 210 defines a head length L₁ of about one-eighth inch (0.32 cm) to about one-quarter inch (0.64 cm), as measured parallel to central longitudinal axis 204.

FIG. 3 is an oblique view of a distal portion of tool 200 of FIGS. 2A-2C, specifically, of distal end 208 of elongated handle 202, and engagement head 210. Engagement head 210 is uniquely sized and shaped to engage with the head of truss-rod adjustment screw 102 of FIG. 1 while up to half of the screw head remains obscured by the body 106 of the instrument. In fact, the “single blade” structure of engagement head 210 is capable of mechanically engaging with industry-standard-sized truss-rod screw heads, regardless of whether the screw 102 is a Phillips-head screw (as in FIG. 1) or a flathead screw.

As illustrated in FIG. 3, single-blade engagement head 210 defines a unique geometric shape, which can nevertheless be described through comparison to an orthogonal right triangle having substantially rounded vertices. For instance, engagement head 210 defines a substantially linear first edge 302, a substantially linear second edge 304 oriented substantially orthogonal to the first edge 302, and a curvilinear third edge 306 (i.e., the “hypotenuse”). Collectively, edges 302/304/306 define a pair of substantially parallel, planar lateral surfaces 308A, 308B therebetween, each of which defines a geometric shape roughly akin to a curvilinear right triangle, as subsequently explained.

First edge 302 is aligned substantially parallel to central longitudinal axis 204 of handle 202, and is configured to directly engage with (i.e., contact) the groove defined by the head of truss-rod screw 102 (FIG. 1). A first portion 302A extends distally (i.e., “upward,” from the perspective shown in FIG. 3) past the distal-most edge 208 of elongated handle 202. A second portion 302B extends proximally (i.e., “downward,” from the perspective shown in of FIG. 3) from distal-most edge 208 of handle 202, such that portion 302B overlaps with a distal portion of handle 202 along central longitudinal axis 204.

Second edge 304 is oriented substantially perpendicular to longitudinal axis 204 and to first edge 302. As shown in FIG. 3, a first portion 304A of second edge 304 extends orthogonally outward from a bottom surface 310 of handle 202. A second portion 304B of second edge 304 extends through the interior of handle 202, from bottom surface 310 of handle 202 to the opposing top surface 312.

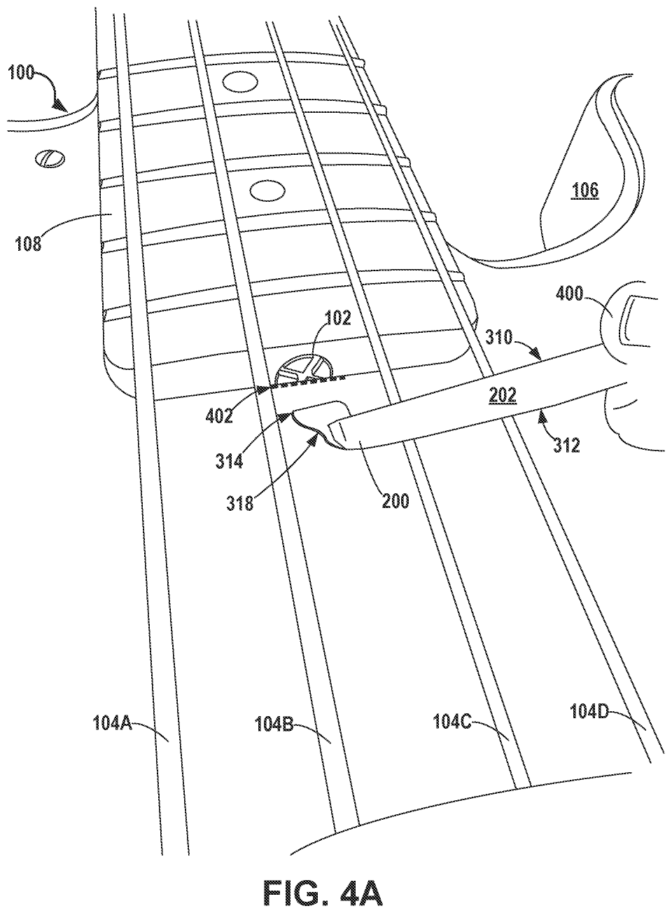

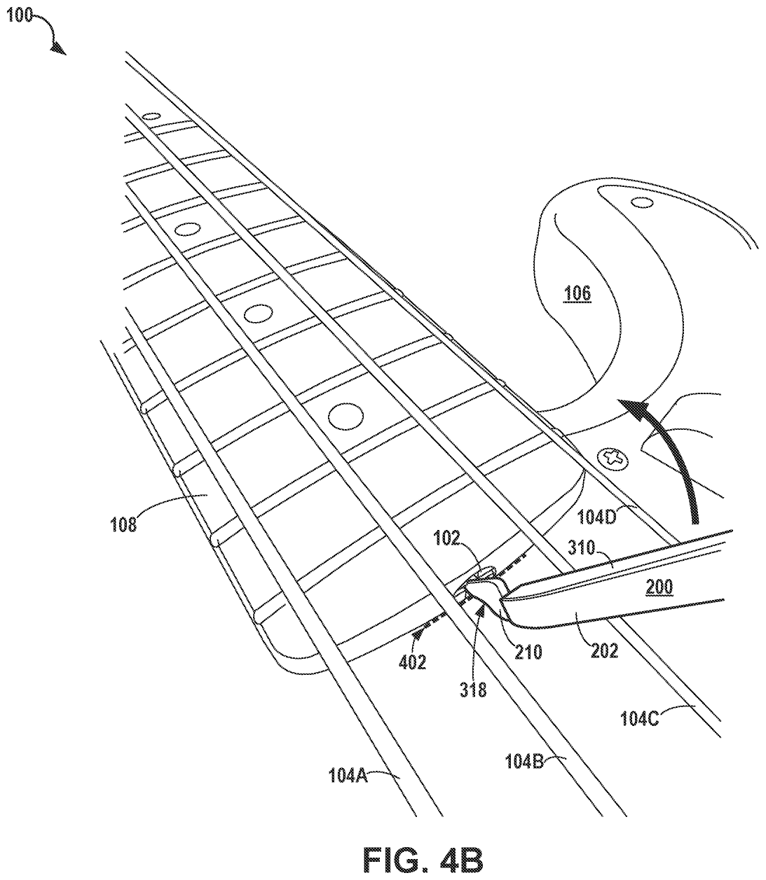

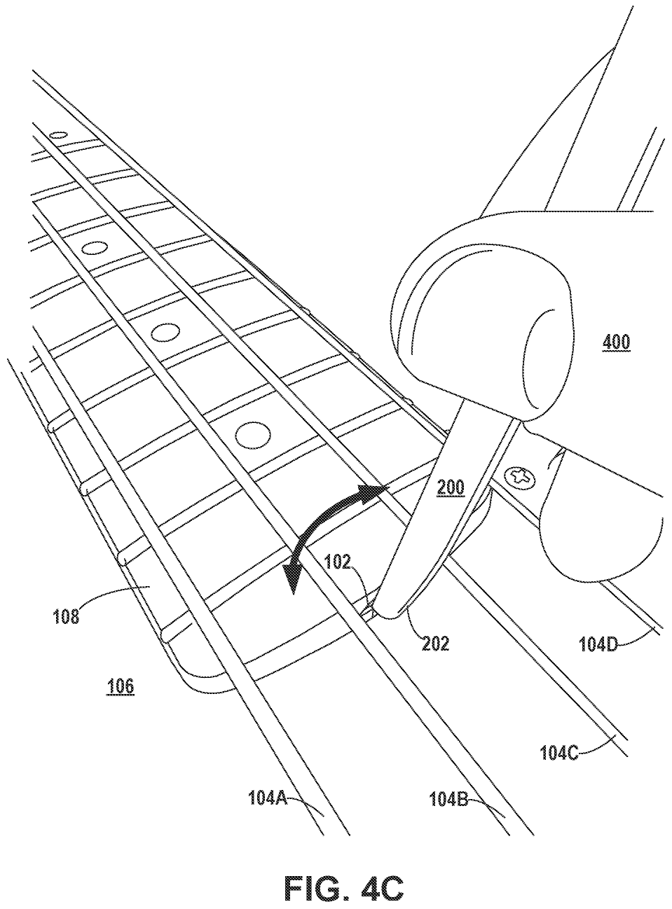

Curvilinear third edge 306 forms the “hypotenuse” of engagement head 210, in that it extends obliquely between the distal-most tip 314 of first edge 302, and the top-most tip 316 of second edge 304. As illustrated sequentially in FIGS. 4A-4C, the sinusoidal shape of third edge 306, and in particular, the concave central portion 318, enables the user 400 to precisely maneuver the engagement head 210 of the tool 200 around the screw-occluding lip 402 of the instrument's body 106, and into the X-shaped head-groove of truss-rod screw 102.

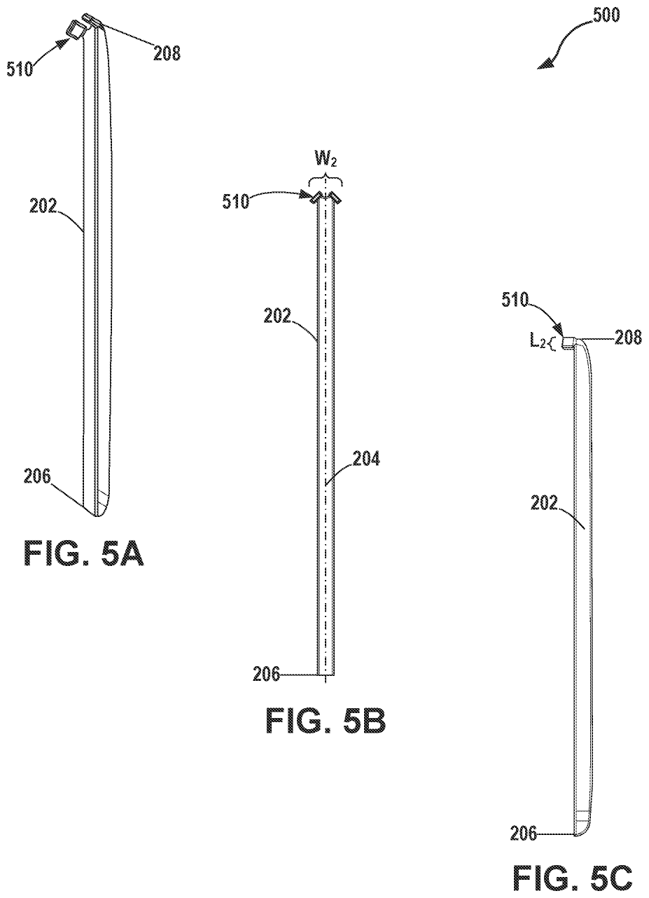

FIGS. 5A-7B illustrate another tool for adjusting an instrument's truss rod 112 while the head of its adjustment screw 102 remains partially occluded by the body 106 of the instrument. Specifically, FIG. 5A is an oblique view, FIG. 5B is a bottom view, and FIG. 5C is a side view, of a second example truss-rod-screw adjustment tool 500 (hereinafter, “tool 500,” or alternatively, “screwdriver 500”). Tool 500 of FIGS. 5A-5C is meant to be understood as an example of tool 200 of FIGS. 2A-2C, apart from the differences explicitly noted herein. For instance, just like tool 200, tool 500 includes an elongated handle 202 that defines a central longitudinal axis 204 between the handle's proximal and distal ends 206, 208, respectively.

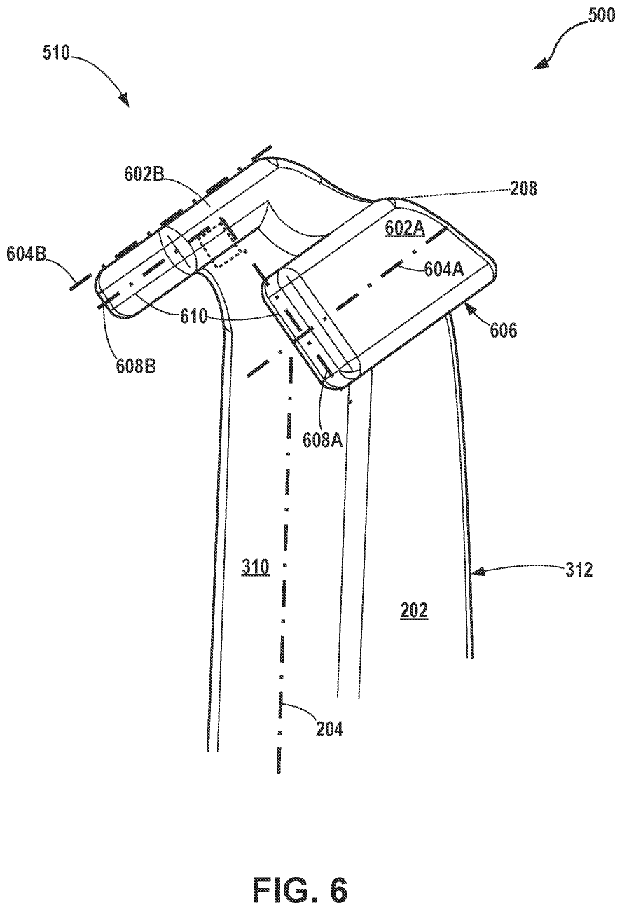

Tool 500 further includes an engagement head 510, which is an example of engagement head 210 of tool 200, and which is illustrated in greater detail in FIG. 6. In some examples, engagement head 510 is integrally formed with handle 202, e.g., from a unitary length of material. In other examples, handle 202 and engagement head 510 are initially formed as physically distinct components (whether from a common or different type of material), and then rigidly coupled (e.g., glued, welded, fused, soldered, nailed, etc.) together. In yet other examples, handle 202 and engagement head 510 are removably coupled to one another. For instance, engagement head 510 can be configured to snap into place within the distal end 208 of handle 202, or can be screwed into place within the distal end 208 of handle 202, or any other mechanism by which engagement head 510 can be non-destructively removed from handle 202 at will.

As shown in FIG. 5B, engagement head 510 defines a head width W₂ of about one-quarter inch (0.64 cm), as measured perpendicular to central longitudinal axis 204. As shown in FIG. 5C, engagement head 510 defines a head length L₂ of about one-eighth inch (0.32 cm) to about one-quarter inch (0.64 cm), as measured parallel to central longitudinal axis 204.

FIG. 6 is an oblique view of a distal portion of tool 500 of FIGS. 5A-5C, namely, of distal end 208 of elongated handle 202, and engagement head 510. Engagement head 510 is uniquely sized and shaped to engage with the head of truss-rod adjustment screw 102 of FIG. 1 while up to half of the screw head remains obscured by the body 106 of the instrument. In particular, engagement head 510 defines a “two-prong” configuration specifically designed to engage with standard-sized Phillips-head truss-rod screws, of the kind depicted in FIGS. 1, 4A-4C, 7A, and 7B, though generally not with flathead truss-rod screws.

As illustrated in FIG. 6, two-prong engagement head 510 defines a mirror-imaged pair of elongated prongs 602A, 602B (collectively, “prongs 602”) centered on opposite sides of central longitudinal axis 204, such that tool 500 is substantially symmetrical about axis 204.

Prongs 602 each define a generally rectangular-prism shape. That is, each prong 602A, 602B defines a respective major axis 604A, 604B that extends through the center of the prong, parallel to the prong's longest edge 606. Major axes 604A, 604B are oriented substantially parallel to one another. Prongs 602 both extend generally downward (i.e., to the left, from the perspective depicted in FIG. 6) from the bottom side 310 of elongated handle 202, such that parallel axes 604 are both substantially orthogonal to central longitudinal axis 204 of handle 202.

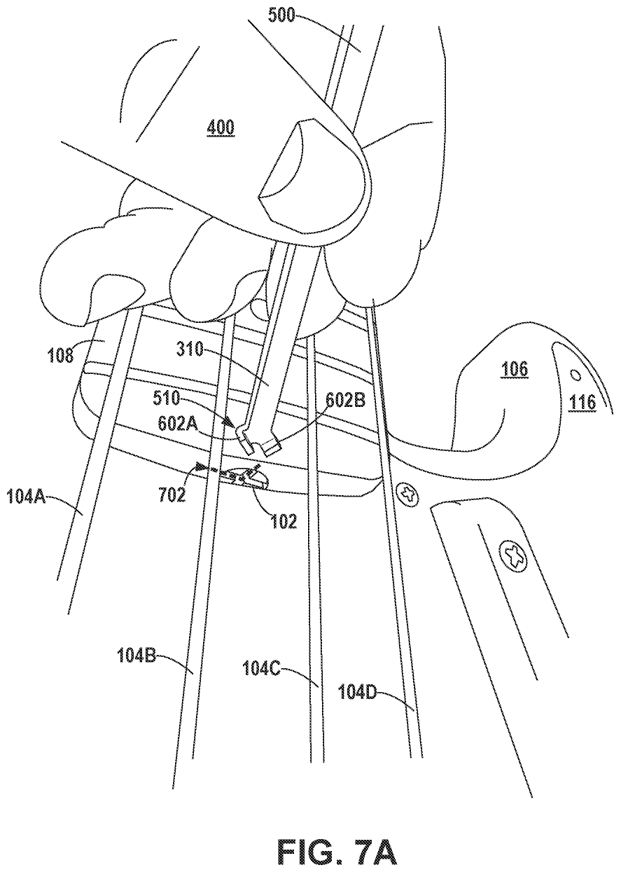

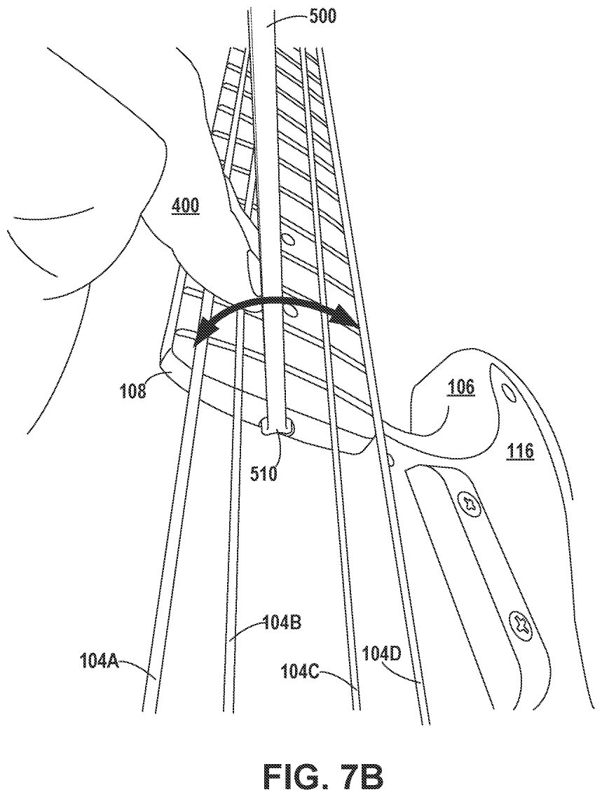

Prongs 602A, 602B further define respective intermediate axes 608A, 608B, extending parallel to the prongs' intermediate-length, bottom-most edges 610. Intermediate axes 608A, 608B are oriented orthogonal to one another such that, as depicted sequentially in FIGS. 7A and 7B, user 400 can conveniently insert engagement head 510 into a corresponding “V” shaped half (702) of the X-shaped groove on the head of a Phillips-head truss-rod screw 102.

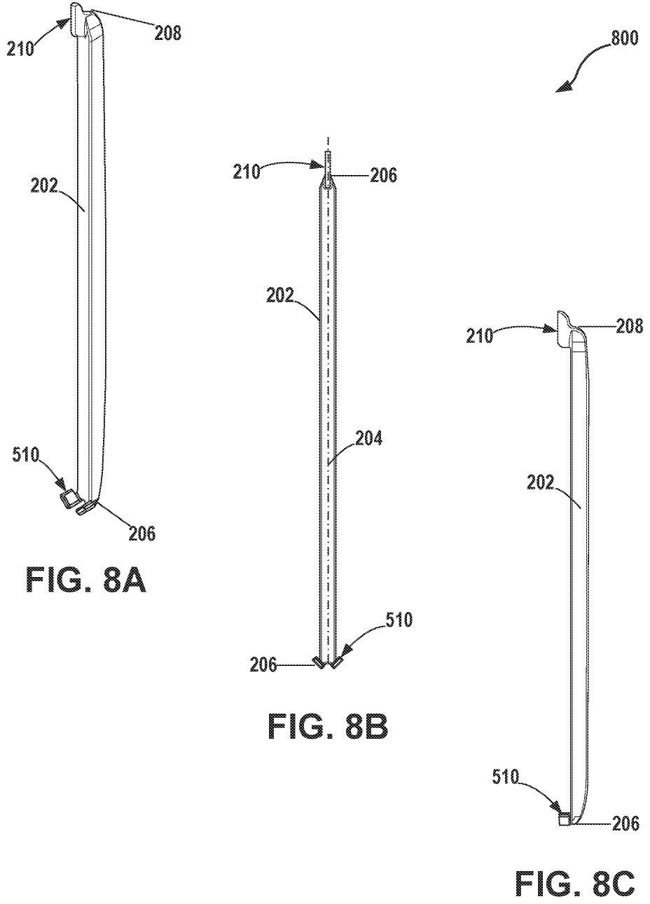

FIGS. 8A-8C illustrate another tool for adjusting a stringed instrument's truss rod 112 (FIG. 1) while the head of its adjustment screw 102 remains partially occluded by the body 106 of the instrument. Specifically, FIG. 8A is an oblique view, FIG. 8B is a bottom view, and FIG. 8C is a side view, of a third example truss-rod-screw adjustment tool 800 (hereinafter, “tool 800,” or alternatively, “screwdriver 800”). Tool 800 of FIGS. 8A-8C is meant to be understood as a simultaneous example of both of tools 200 of FIGS. 2A-2C and 500 of FIGS. 5A-5C. That is, tool 800 is a double-ended truss-rod-screw adjustment tool, having a different type of engagement head at either end of elongated handle 202.

Just like tools 200 and 500, elongated handle 202 of tool 800 defines a central longitudinal axis 204 extending between a “first” end 206 and a “second” end 208. A first engagement head 510, having a two-prong configuration (as described above with respect to FIG. 6), is coupled to the first end 206 of handle 202. A second engagement head 210, having a single-blade configuration (as described above with respect to FIG. 3), is coupled to the second end 208 of handle 202. Note that, since this example of handle 202 is both longitudinally symmetrical and functionally reversible, either one of ends 206/208 can become the designated “proximal” or “distal” end. Conventionally, “proximal” refers to the end of a tool that extends toward the user while the tool is in use, and “distal” refers to the end that extends away from the user (typically, the actively “functional” end). Accordingly, the “distal” end of tool 800 is determined by which engagement head the user is inserting into the truss-rod screw 102 at that time.

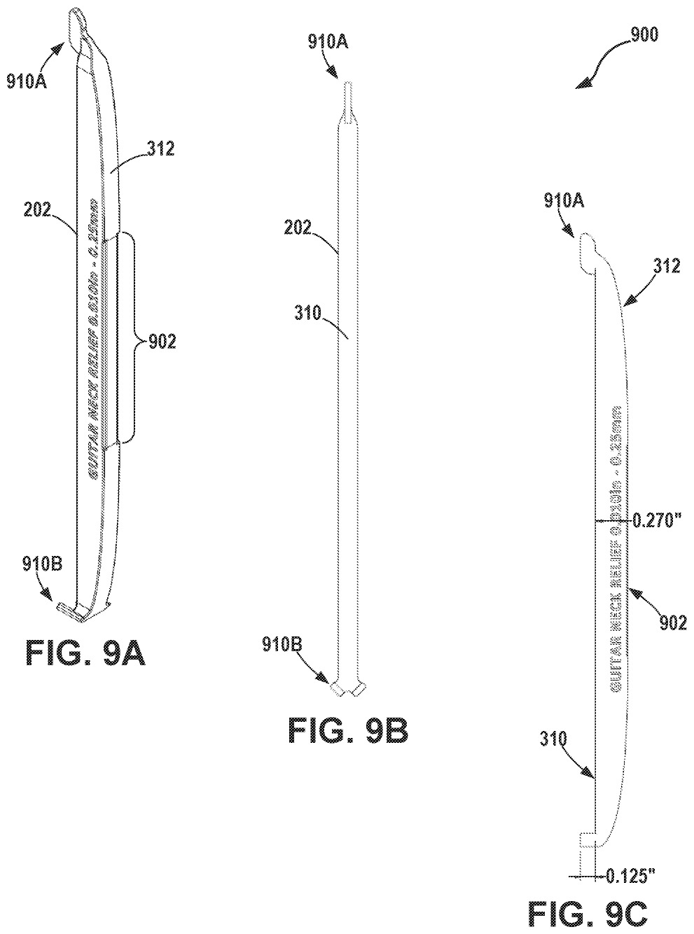

FIGS. 9A-15 illustrate another example tool for adjusting a stringed instrument's truss rod 112 (FIG. 1) while the head of its adjustment screw 102 remains partially occluded by the body 106 of the instrument. Specifically, FIG. 9A is an oblique view, FIG. 9B is a bottom view, and FIG. 9C is a side view, of a fourth example truss-rod-screw adjustment tool 900 (hereinafter, “tool 900,” or alternatively, “screwdriver 900”). Tool 900 of FIGS. 9A-9C is an example of tool 800 of FIGS. 8A-8C, apart from the differences noted herein. In particular, as shown in FIG. 9A (and as detailed further below), the top surface 312 of handle 202 includes an integrated action ruler 902.

Similar to tool 800, tool 900 of FIGS. 9A-9C includes both a single-blade engagement head 910A (e.g., engagement head 210) and a two-prong engagement head 910B (e.g., engagement head 510) at opposite ends of handle 202. As indicated in FIG. 9C, handle 202 can have a depth, extending from its bottom surface 310 to its top surface 312, of about 0.270 inches. It is to be understood that all of the example dimensions provided herein are merely examples, and inherently define the centerpoint of a corresponding range of tolerated dimensions of up to about 25% on either side of the specified value. For instance, the example handle width of 0.270″ has been contemplated to range from about 0.2025″ to about 0.3375″ without meaningfully deviating from the functionality of the handle 202.

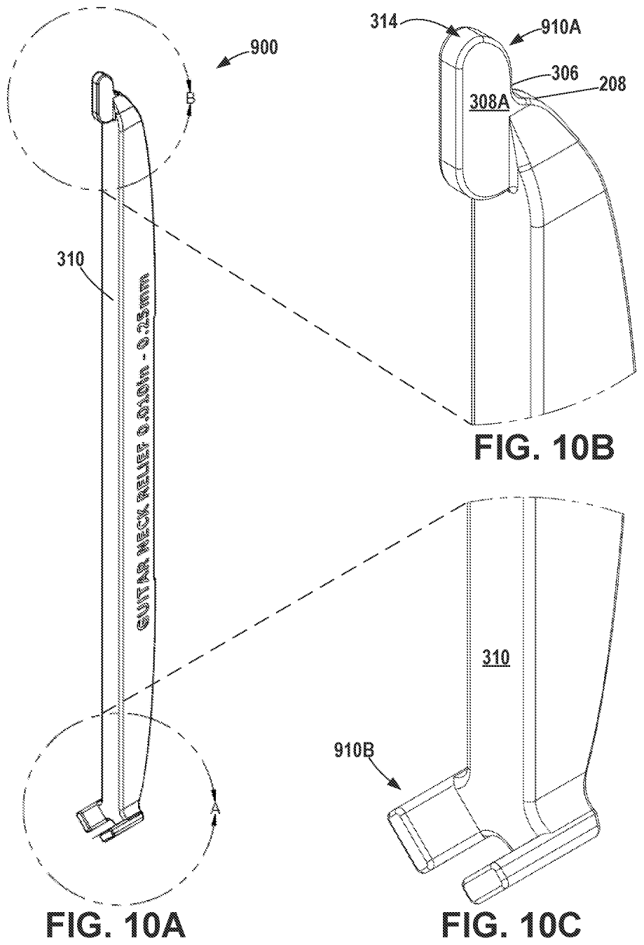

FIG. 10A is a perspective view of the double-ended tool 900 of FIGS. 9A-9C. A close-up view of the distal end of tool 900 is shown in FIG. 10B, and a close-up view of the proximal end of tool 900 is shown in FIG. 10C. As shown in FIG. 10B, the distal end of tool 900 includes a single-bladed engagement head 910A, which is an example of engagement head 210 of FIGS. 2A-4C and 8. However, the geometric shape of engagement head 910A is marginally different from the previous examples. That is, the curvilinear third edge 306 of engagement head 910A is notably “steeper” than in engagement head 210, such that planar surface 308A more-closely approximates an elongated-oval shape, similar to the outer profile of a pill capsule, rather than a right triangle.

In other examples, the distal-most tip 314 of engagement head 910A can be substantially flatter than the rounded version depicted in FIG. 10B. In such cases, engagement head 910A more closely approximates a rectangular-prism shape, extending at least partially past the distal-most end 208 of handle 202. That is, planar surface 308A can form a generally quadrilateral shape, such as an elongated rectangle, while retaining substantially the same relative dimensions as those depicted.

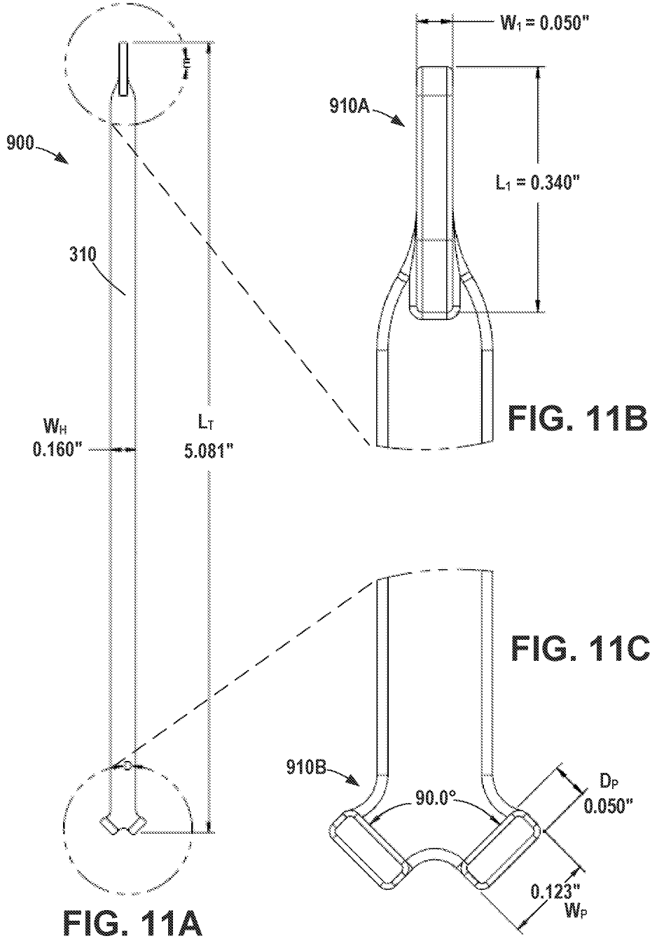

FIGS. 11A-11C depict the bottom surface or underside of tool 900 of FIGS. 9A-9C to illustrate some example relative dimensions of these components. The values provided are once again noted to be representative of an inherent range of acceptable values, extending up to about 25% on either side of the indicated value. As shown in FIG. 11A, tool 900 defines an overall tool length L_{T} of about 5.018 inches (e.g., about 3.75 inches to about 6.25 inches), having a handle width W_{H} of about 0.160 inches. As shown in FIG. 11B, engagement head 910A defines a head width W₁ of about 0.050 inches, and a head length L₁ of about 0.340 inches. As shown in FIG. 11C, each prong of engagement head 910B defines a prong width W_{P} of about 0.123 inches, and a prong depth D_{P} of about 0.050 inches.

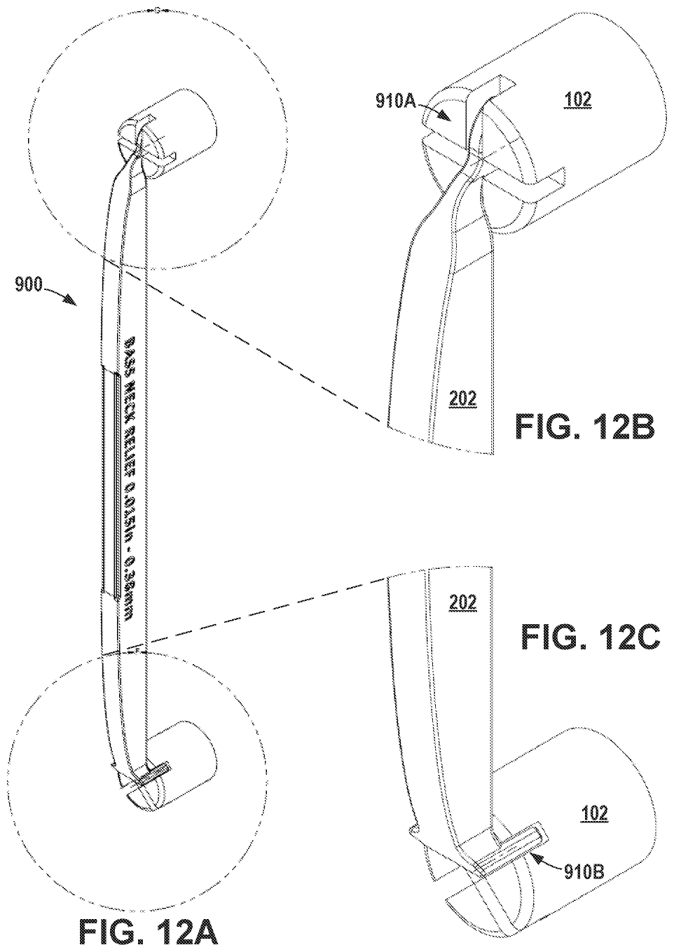

FIGS. 12A-12C are conceptual diagrams illustrating how each engagement head 910A, 910B engages with a truss-rod adjustment screw 102. The screw 102 is depicted in FIGS. 12A-12C as a Phillips-head screw, however, as previously noted, single-blade engagement head 910A can engage equally well with a flathead screw.

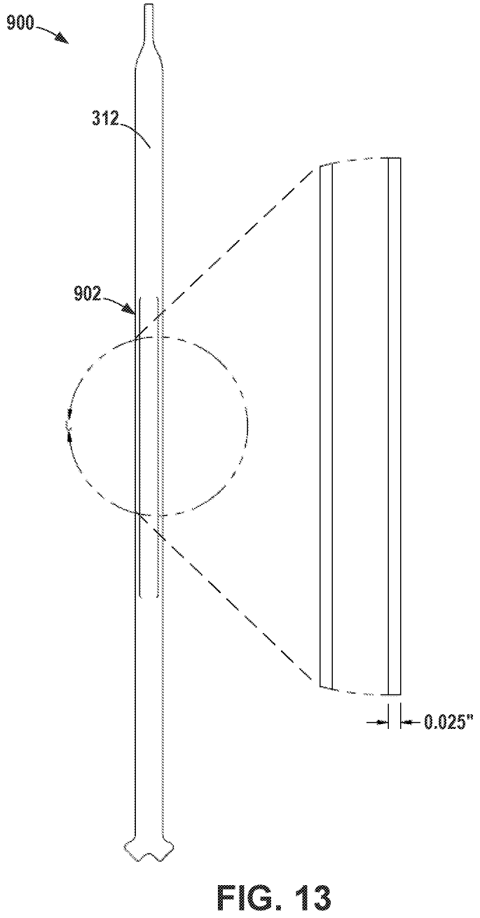

As referenced above, truss-rod adjustment tool 900 represents an example in which top surface 312 of handle 202 features a built-in action ruler 902 to assist the user in determining the appropriate amount of relief (or neck-curvature) to apply via the tool. FIGS. 13-15 show some close-up views of various portions of the ruler 902. For instance, as shown in FIG. 13, a length of material is cut away from both opposite edges of top side 312 of handle 202. Each “missing” portion can define a width of about 0.025 inches.

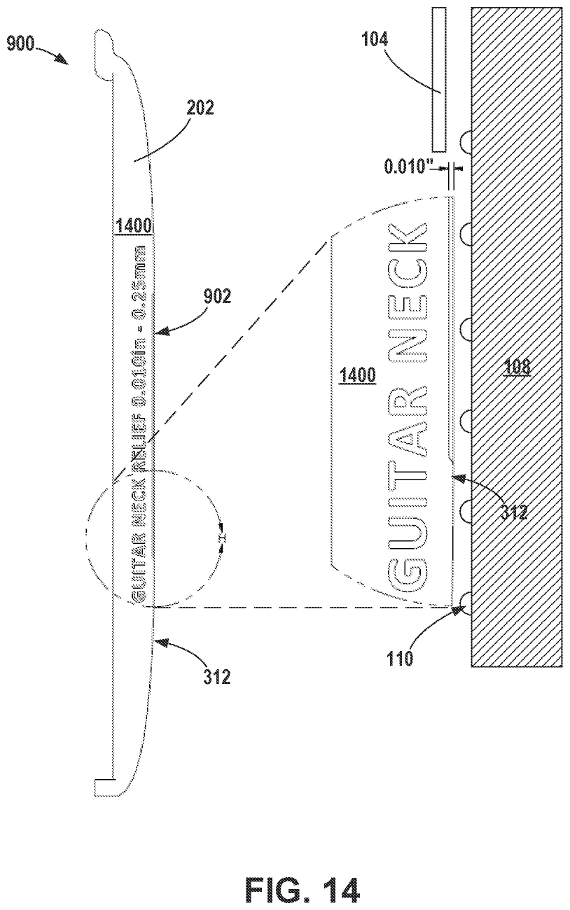

FIG. 14 shows a first example implementation of action ruler 902, tailored specifically for adjusting the relief of a guitar. Specifically, a left-hand side 1400 of handle 202 includes a notch or other marking that defines a precise depth away from top surface 312. During use, truss-rod tool 900 is laid down on top of the neck 108 of the guitar, such that top surface 312 of handle 202 is resting against the fret board 110. From this position, the guitar strings 104 should be aligned with the inner edge of the action ruler 902, or in other words, should define a gap of approximately 0.010 inches between the string 104 and the fret board 110. If this gap is discernably larger or smaller than the indicated depth, then the user can employ truss-rod tool 900 to modify the relief of the neck 108, and thereby, the action of the strings 104.

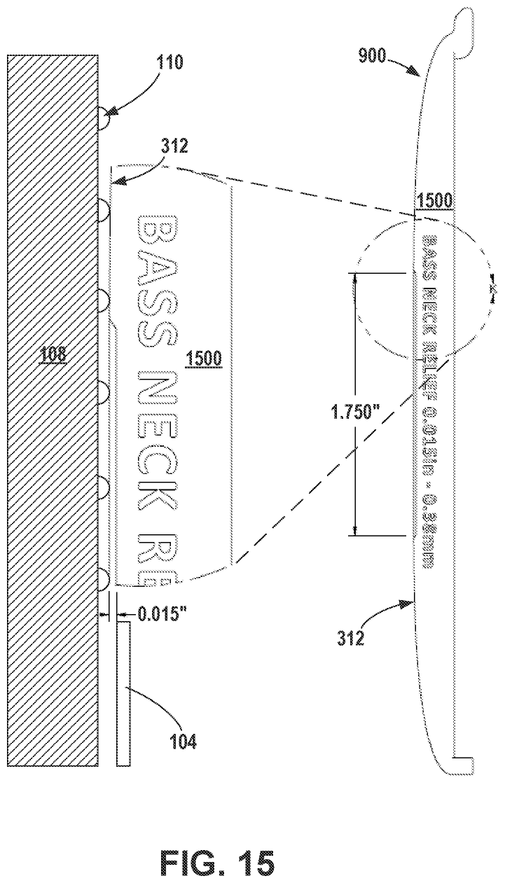

FIG. 15 shows a second example implementation of action ruler 902, tailored specifically for adjusting the relief of a bass guitar. Specifically, a right-hand side 1500 of handle 202 includes a notch or other marking that defines a precise depth away from top surface 312. During use, truss-rod tool 900 is laid down on top of the neck 108 of the bass guitar, such that top surface 312 of handle 202 is resting against the fret board 110. From this position, the bass-guitar strings 104 should be aligned with the inner edge of the action ruler 902, or in other words, should define a gap of approximately 0.015 inches between the string 104 and the fret board 110. If this gap is discernably larger or smaller than the indicated depth, then the user can employ truss-rod tool 900 to modify the relief of the neck 108, and thereby, the action of the strings 104.

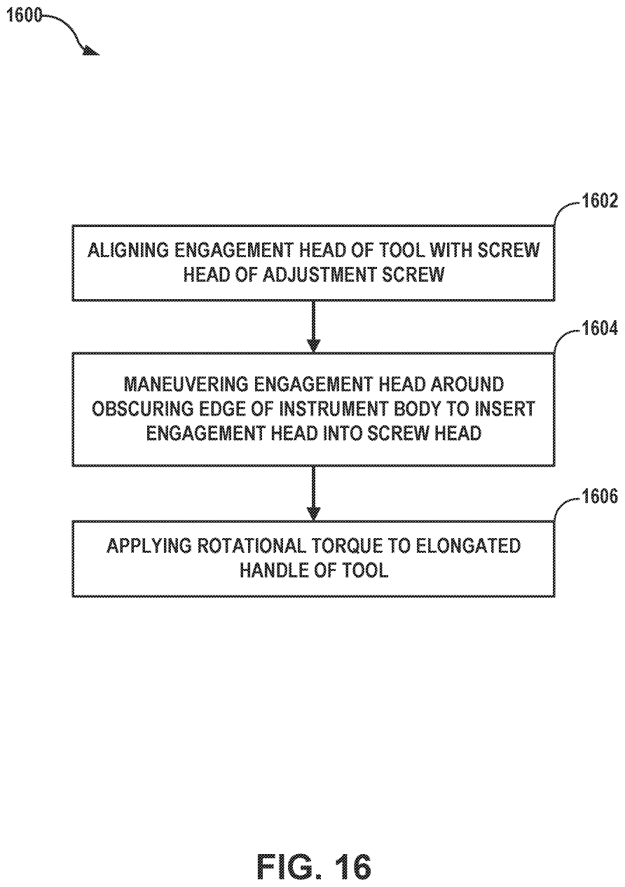

FIG. 16 is a flowchart 1600 describing a method for adjusting the truss rod 112 (FIG. 1) within the neck 108 of a stringed musical instrument 100 while the instrument remains fully assembled and while the truss-rod adjustment screw 102 remains partially obscured by the body 106 of the instrument 100. As shown in FIG. 16, the method 1600 includes: (1) At Step 1602, aligning the engagement head 210/510 of a specialized tool 200/500/800 with the screw head of the truss-rod adjustment screw 102; (2) At Step 1604, maneuvering the engagement head 210/510 around the obscuring edge 402 of the body 106 of the stringed musical instrument 100 in order to insert the engagement head 210/510 into the head of the screw 102; and (3) At Step 1606, applying rotational torque to the elongated handle 202 of the tool 200/500/800 in order to rotate the adjustment screw 102, in order to bend or straighten the truss rod 112, in order to bend or straighten the neck 108 of the musical instrument 100.

It should be understood that individual steps of the previous examples may be performed in any suitable order and/or simultaneously, as long as the overall technique remains operable. Similarly, various aspects disclosed herein may be combined in different combinations than those explicitly presented in the description and accompanying drawings.

What is claimed is:

1. A tool configured to adjust a truss rod disposed within a neck of a stringed musical instrument, the tool comprising:
an elongated handle defining a proximal end, a distal end, and a central longitudinal axis extending from the proximal end to the distal end; and
an engagement head coupled to the distal end of the elongated handle, wherein the engagement head is configured to engage with a screw head of an adjustment screw coupled to the truss rod while the screw head is partially obscured by a body of the instrument.

2. The tool of claim 1, wherein the adjustment screw comprises a Phillips-head screw or a flathead screw, and wherein the engagement head comprises:
a substantially linear first edge oriented parallel to the central longitudinal axis of the elongated handle, the first straight edge being configured to engage with the screw head;
a substantially linear second edge disposed on a proximal side of the engagement head, the second straight edge oriented perpendicular to the first straight edge, and extending between the first straight edge and the elongated handle; and
a curvilinear third edge disposed on a distal side of the engagement head, the third edge extending between the first edge and the elongated handle.

3. The tool of claim 2, wherein:
the adjustment screw comprises the Phillips-head screw;
the engagement head comprises a first engagement head;
the tool further comprises a second engagement head coupled to the proximal end of the elongated handle; and
the second engagement head is configured to engage with the screw head of the adjustment screw while the screw head is partially obscured by the body of the instrument.

4. The tool of claim 3, wherein:
the second engagement head comprises a first prong and a second prong;
the first prong and the second prong are symmetrically positioned on opposite sides of the proximal end of the elongated handle; and
a first intermediate axis of the first prong is oriented at a 90-degree angle relative to a second intermediate axis of the second prong.

5. The tool of claim 4, wherein the second engagement head defines an overall width of about one-quarter inch, the overall width being measured orthogonal to the central longitudinal axis of the elongated handle.

6. The tool of claim 1, wherein:
the adjustment screw comprises a Phillips-head screw;
the engagement head comprises a first prong and a second prong;
the first prong and the second prong are symmetrically positioned on opposite sides of the distal end of the elongated handle; and
a first intermediate axis of the first prong is oriented at a 90-degree angle relative to a second intermediate axis of the second prong.

7. The tool of claim 6, wherein the engagement head defines an overall width of about one-quarter inch, the overall width being measured orthogonal to the central longitudinal axis of the elongated handle.

8. The tool of claim 1, wherein the tool is composed of stainless steel.

9. The tool of claim 1, wherein the tool defines an overall length of about five-and-one-eighth inches, wherein the overall length is measured parallel to the central longitudinal axis of the elongated handle.

10. The tool of claim 1, wherein the elongated handle defines a handle width of about one-eighth inch, the handle width being measured orthogonal to the central longitudinal axis.

11. The tool of claim 1, wherein a top surface of the elongated handle comprises an integrated action ruler.

12. A method of adjusting a truss rod disposed within a neck of a stringed musical instrument while the screw head is partially obscured by a body of the instrument, the method comprising:
inserting an engagement head of a tool into a screw head of an adjustment screw coupled to the truss rod, wherein the adjustment screw comprises a Phillips-head screw or a flathead screw; and
applying torque to an elongated handle of the tool to rotate the adjustment screw, wherein the elongated handle defines a central longitudinal axis, and wherein the engagement head is coupled to the distal end of the elongated handle.

13. The method of claim 12, wherein the engagement head comprises:
a substantially linear first edge oriented parallel to the central longitudinal axis of the elongated handle, the first edge being configured to engage with the screw head;
a substantially linear second edge disposed on a proximal side of the engagement head, the second edge oriented perpendicular to the first edge, and extending between the first edge and the elongated handle; and
a curvilinear third edge disposed on a distal side of the engagement head, the curvilinear edge extending between the first edge and the elongated handle.

14. The method of claim 12, wherein:
the adjustment screw comprises the Phillips-head screw;
the engagement head comprises a first prong and a second prong;
the first prong and the second prong are symmetrically positioned on opposite sides of the distal end of the elongated handle; and
a first intermediate axis of the first prong is oriented at a 90-degree angle relative to a second intermediate axis of the second prong.

15. The method of claim 14, wherein the engagement head defines a width of about one-quarter inch, the width being measured orthogonal to the central longitudinal axis of the elongated handle.

16. The method of claim 12, wherein the tool is composed of stainless steel.

17. The method of claim 12, wherein the tool defines an overall length of about five-and-one-eighth inches, wherein the overall length is measured parallel to the central longitudinal axis of the elongated handle.

18. The method of claim 12, wherein the elongated handle defines a handle width of about one-eighth inch, the handle width being measured orthogonal to the central longitudinal axis.

19. The method of claim 12, wherein a top surface of the elongated handle defines an integrated action ruler.

20. A method of making a tool configured to adjust a truss rod disposed within a neck of a stringed musical instrument, the method comprising:
forming an elongated handle defining a proximal end, a distal end, and a central longitudinal axis extending from the proximal end to the distal end; and
coupling an engagement head to the distal end of the elongated handle, wherein the engagement head is configured to engage with a screw head of an adjustment screw coupled to the truss rod while the screw head is partially obscured by a body of the instrument.
